(19) United States
(12) Patent Application Publication
(10) Pub. No.: US 2002/0076965 A1
(43) Pub. Date: Jun. 20, 2002

(54) Sealing element for an electrical plug device

(76) Inventors: Markus Lux, Waiblingen (DE); Andreas Simmel, Schwaikheim (DE)

Correspondence Address: KENYON & KENYON, ONE BROADWAY, NEW YORK, NY, 10004, US

(21) Appl. No.: 09/967,037

(22) Filed: Sep. 28, 2001

(30) Foreign Application Priority Data
Sep. 28, 2000 (DE) 100 48 062.4

(51) Int. Cl. H01R 13/52

(52) U.S. Cl. 439/271

(57) ABSTRACT

A sealing element for an electrical plug device is to be designed in such a manner that the plug device remains functional with regard to its sealing, when a first connector and a second connector of the plug device are joined. To this end, the elastomer sealing element, which includes a substructure having a rectangular cross-section, and lamellae projecting from the substructure, has its substructure dimensioned such that the ratio of its axially running height H to its radially running width B is less than or equal to 8. In addition, the substructure is inserted in a recess on the first connector, in a positionally secure manner. The sealing element is particularly intended for use in the automotive industry.

### FIELD OF THE INVENTION

The present invention relates to a sealing element for an electrical plug device.

### BACKGROUND INFORMATION

A sealing element is describe in German Published Patent Application No. 197 43 104, for an electrical connector which, as a part of an electrical plug device, can be detachably connected to a mating connector.

The sealing element is in the form of a circular, closed, radial seal, which is indirectly supported at a housing of the connector, on a collar. The sealing element has a substructure having an essentially rectangular cross-sectional area. On the outside, a plurality of axially spaced, radially directed sealing lips rise up from the substructure.

When the connector is joined to the mating connector, the sealing lips frictionally abut against an inner side of a guide sleeve of the mating connector, which is inserted into a corresponding guide conduit of the connector. In this context, axial movement of the sealing element in the insertion direction of the guide collar is prevented by a shoulder, which partly supports the substructure.

In the case of plug devices which, due to miniaturization efforts, may only have a very small unit volume, a small radial space between the collar of the connector and the inside of the guide sleeve of the mating connector, which in turn only allows a small overall height of the sealing element, can cause malfunctions at the sealing element. If the substructure is designed to be very thin in order to still maintain the permissible height of the sealing element, then the stiffness of the substructure becomes so small that a secure connection of the connector can no longer be ensured. The seal is then warped in response to sliding the guide sleeve onto the sealing element.

A seal compressed in such manner prevents the plug device from being completely closed, and does not allow it to seal.

If, on the other hand, the substructure having a suitable overall height is designed to be sufficiently stiff and, to compensate for this, the sealing lips are formed to have a lower overall height, then the plug device can be closed without distorting the sealing element, but only at the expense of the sealing element not being sufficiently compressed for sealing.

For a functional plug device, it is undesirable to have a distorted sealing element, and for the sealing action of the sealing element to be inadequate.

### SUMMARY OF THE INVENTION

In contrast, the sealing element according to the present invention, for an electrical plug device has the advantage of the above-mentioned shortcomings being prevented to a satisfactory extent. To this end, the substructure of the sealing element is dimensioned to have a ratio of its axially running height H to its radially running width B of less than or equal to 8.

This ensures that the substructure even remains undistorted in response to axial pressure being applied to the sealing members projecting out from it, and that the sealing element possesses the required inherent stiffness for reliably sealing the plug device.

In addition, at least the base of the sealing element is sunk into a recess formed on the first connector. Enclosing the sealing element in this manner provides it with a supporting dimensional stability, which forms a redundancy against the sealing element deforming in response to joining the two connectors.

Thus, the prerequisites for reliable sealing action of the sealing element at the plug device are fulfilled.

### BRIEF DESCRIPTION OF THE DRAWINGS

FIG. 1 shows a sectional view of a cut-away portion of a plug device.

FIG. 2 shows a sectional view of a sealing element.

### DETAILED DESCRIPTION

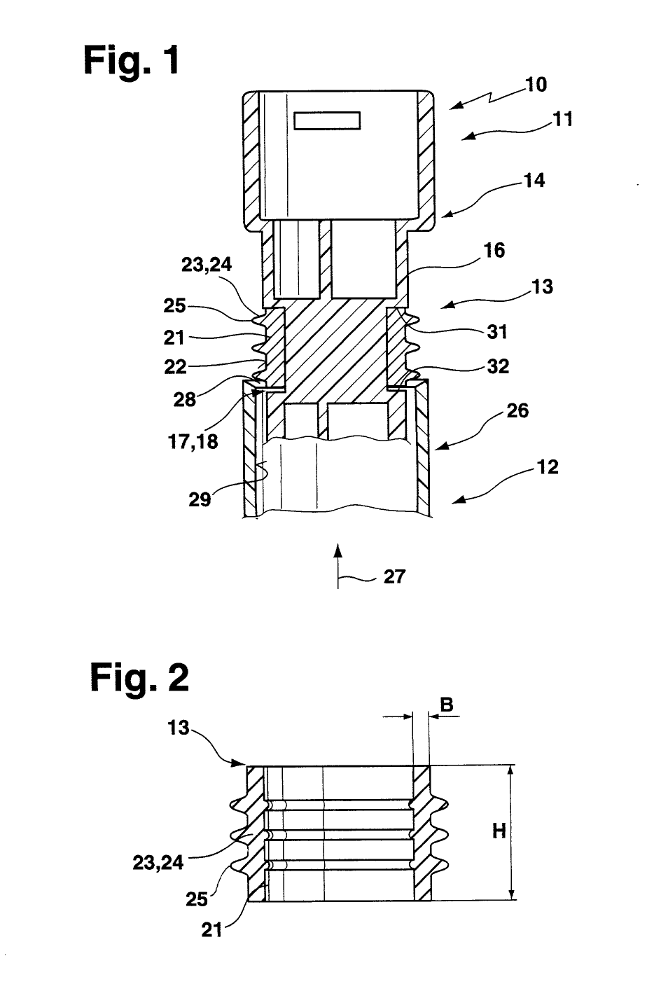

An electrical plug device 10 according to FIG. 1 has a first connector 11, a second connector 12, and a sealing element 13 as main components. The two connectors 11, 12 can be reversibly coupled to each other, sealing element 13 sealing joined connectors 11, 12 with respect to each other and thus protecting plug device 10 from external influences, in particular sprayed water.

First connector 11 has an oblong plug-connector housing 14 made of plastic. In a known manner not shown in further detail, contact elements are present in first connector 11 for contacting counter-contact elements of second connector 12, which is only shown to illustrate the connection. The number and arrangement of the contact elements is determined by the cross-sectional area of connector housing 14. In this exemplary embodiment, they are arranged in a circle for attachment; as an alternative, they may also be rectangular for attachment, with rounded corners.

Connector housing 14 includes an oblong guide collar 16, which faces second connector 12, and whose cross-sectional area is constant over the longitudinal path, only being regionally reduced by an intermediate recess 17. Recess 17 is in the form of an annular groove 18 having a rectangular cross-sectional area. Sealing element 13, which is made of an elastomer and shown separately in FIG. 2, is inserted into annular groove 18 in a stretched, resilient state.

Sealing element 13 is annularly shaped. It has a substructure 21 having a rectangular cross-section, whose axial extension is designated in FIG. 2 by H for its height, and whose radial extension is designated here by B for its width. Radially aligned sealing members 23, which are axially spaced and parallel to each other, rise up from outer side 22 of substructure 21 in the form of lamellae 24, each of which have a cross-section taking the form of an isosceles triangle, a leg of the triangle running along outer side 22. Alternatively, lamellae 24 can be provided with a different cross-section which, for example, has the shape of a semiellipse.

The external, projecting arrangement of lamellae 24, which form one piece with substructure 21 and each have a tapered free end 25, allows them to be easily deflected at this free end.

A subsection of a sleeve-shaped receiving member 26 of second connector 12, which is only represented in FIG. 1 to illustrate the connection, is shown, the shape and internal diameter of the sleeve-shaped receiving member being matched to the guide collar 16 having sealing element 13, in such a manner, that, in response to receiving member 26 being slid in the direction of an arrow 27, onto guide collar 16, lamellae 24 are gripped by an insertion funnel 28 at the end face of receiving member 26.

When one continues to bring the two connectors 11, 12 together, in which case one can, as an alternative, partially insert first connector 11 in the opposite direction of arrow 27, into second connector 12, then free ends 25 of lamellae 24 are deflected by an inner wall 29 of guide collar 16.

The axial forces acting on sealing element 13 in response to the two connectors 11, 12 being brought together are transmitted from lamellae 24 to substructure 21, which is axially supported against a radially running, first stop face 31 of annular groove 18, or against a radially running, second stop face 32 of annular groove 18 in response to the two connectors 11, 12 being separated.

In this context, substructure 21, and therefore sealing element 13, are not pressed together or deformed, since the inherent stiffness of substructure 21 is sufficient, due to the ratio of its axially running height H to its radially running width B being less than or equal to 9.

In addition, the radially running depth of annular groove 18 is dimensioned such that substructure 21 is completely inserted into annular groove 18, and can therefore not be gripped by guide collar 16 of second connector 12 at all. Enclosing a substantial portion of substructure 21 in this manner provides it with a supporting dimensional stability, which forms a redundancy against sealing element 19 deforming in response to the two connectors 11, 12 being coupled.

On a substructure 21 stabilized to such an extent, it is possible to select the radial extension of lamellae 24 to be large enough in all of the tolerance positions of guide collar 16, sealing element 13, and receiving member 26, to achieve the contact pressure on free ends 25 of lamellae 24, at inner wall 29, for adequately sealing plug device 10.

What is claimed is:

1. A sealing element for an electrical plug device, comprising:
a substructure including a rectangular cross-sectional area; and
a plurality of sealing members projecting outward from the substructure, wherein:
the substructure is capable of being externally supported in a recess formed on a first connector of the electrical plug device, the first connector being capable of being reversibly coupled to a second connector of the electrical plug device,
the second connector applies a force to the substructure when the first connector and the second connector are brought together axially in an insertion direction,
at least the sealing members protrude from the recess in at least some regions, and
the substructure is dimensioned such that a ratio of an axially running height H thereof to a radially running width B thereof is less than or equal to 8.

2. The sealing element according to claim 1, wherein:
the substructure is inserted in the recess, and
at least some regions of the substructure are inserted in the recess.

3. The sealing element according to claim 2, wherein:
the substructure is inserted flush in the recess.

4. The sealing element according to claim 3, wherein:
the recess is formed as an annular groove.

5. The sealing element according to claim 4, wherein:
the substructure is inserted in the recess in a stretched, prestressed state.

6. The sealing element according to claim 1, wherein:
the sealing members jut out of an outer side of the substructure opposite to the recess, and
the sealing members form one piece with the substructure.

7. The sealing element according to claim 6, wherein:
the sealing members include radially directed lamellae that are axially and parallelly spaced and run in a closed circle.

8. The sealing element according to claim 7, wherein:
the second connector includes a sleeve-shaped receiving member that, in response to the first connector and the second connector being brought together, grips the lamellae and deforms the lamellae in some regions, in opposition to a restoring force of the lamellae.
